(19) United States
(12) Patent Application Publication
(10) Pub. No.: US 2023/0369917 A1
(43) Pub. Date: Nov. 16, 2023

(54) POWER CONTRACT POLICY FOR WIRELESS CHARGING

(71) Applicant: Apple Inc., Cupertino, CA (US)

(72) Inventor: Ali Abdolkhani

(21) Appl. No.: 17/814,091

(22) Filed: Jul. 21, 2022

Related U.S. Application Data
(60) Provisional application No. 63/364,463, filed on May 10, 2022.

(51) Int. Cl. H02J 50/80; H02J 50/10; H02J 7/00

(52) U.S. Cl. CPC H02J 50/80; H02J 50/10; H02J 7/00045; H02J 7/007

(57) ABSTRACT

A wireless power transmitter can include an inverter that receives input power and generates an AC output voltage, a wireless power transmitter coil coupled to the AC output that magnetically couples to a corresponding coil of a wireless power receiver, and a controller and communication module. The controller and communication module can receive identifying information from the wireless power receiver, receive voltage information from the wireless power receiver, compute a coupling factor with the wireless power receiver based at least in part on the received identifying information and the received voltage information, computes a power transfer level based on the computed coupling factor, and negotiate a power contract with the wireless power receiver based at least in part on the computed power transfer level.

### CROSS-REFERENCE TO RELATED APPLICATIONS

This application claims priority to U.S. Provisional Application No. 63/364,463, filed May 10, 2022, entitled “POWER CONTRACT POLICY FOR WIRELESS CHARGING,” the disclosure of which is incorporated by reference in its entirety for all purposes.

### BACKGROUND

Wireless power transfer (“WPT”), such as inductive power transfer (“IPT”), may be used to provide power for charging various battery-powered electronic devices. One application in which WPT has seen increases in use is the consumer electronics space around devices such as mobile phones (i.e., smart phones) and their accessories (e.g., wireless earphones, smart watches, etc.) as well as tablets and other types of portable computers and their accessories (e.g., styluses, etc.).

### SUMMARY

A wireless power transmitter can include an inverter that receives input power and generates an AC output voltage, a wireless power transmitter coil coupled to the AC output that magnetically couples to a corresponding coil of a wireless power receiver, and a controller and communication module. The controller and communication module can receive identifying information from the wireless power receiver, receive voltage information from the wireless power receiver, compute a coupling factor with the wireless power receiver based at least in part on the received identifying information and the received voltage information, computes a power transfer level based on the computed coupling factor, and negotiate a power contract with the wireless power receiver based at least in part on the computed power transfer level.

The identifying information can specifically identify the wireless power receiver. The identifying information can identify the wireless power receiver as a member of a class of wireless power receivers.

The coupling factor can be computed in accordance with the equation:

$$k = \frac{{C}_{0} \cdot {V}_{rect}}{{V}_{inv} + {VCTX}_{pp}} + C 1$$

where k is the coupling factor, Vrect is a rectifier voltage that is at least a part of the received voltage information, Vinv is the input DC voltage to the inverter, VCTXpp is a peak voltage across a transmitter tuning capacitor, and C0 and C1 are fit coefficients.

The power transfer level can be computed in accordance with the equation:

P_{target}=k²·C_{pwr}

where Ptarget is power deliverable to the receiver, k is the coupling factor, and Cpwr is a constant for a transmitter/receiver combination determined by the controller based at least in part on the received receiver identifying information. Cpwr can be stored in a memory of the controller and retrieved based at least in part on the received receiver identifying information. Cpwr can be contained in the received receiver identifying information. Cpwr can be computed according to the formula:

$${C}_{pwr} = \frac{{P}_{rect\_max} + {R}_{X L o s s}}{{k}_{min}^{2}}$$

where Prect_max is the maximum total power level required by the receiver, RXLoss is the power lost in the receiver, and kmin is the minimum coupling coefficient that corresponds to a maximum acceptable displacement between transmitter and receiver.

A method performed by a wireless power transmitter of negotiating a wireless power delivery contract with a wireless power receiver can include receiving identifying information from the wireless power receiver via a wireless communication link, receiving voltage information from the wireless power receiver via the wireless communication link, computing with a processor of the wireless power transmitter a coupling factor with the wireless power receiver based at least in part on the received identifying information and the received voltage information, computing with the processor a power transfer level based on the computed coupling factor, and negotiating the wireless power delivery contract based at least in part on the computed power transfer level.

The identifying information can specifically identify the wireless power receiver. The identifying information identifies the wireless power receiver as a member of a class of wireless power receivers.

The coupling factor can be computed in accordance with the equation:

$$k = \frac{{C}_{0} \cdot {V}_{rect}}{{V}_{i n v} + V {CTX}_{p p}} + C 1$$

where k is the coupling factor, Vrect is a rectifier voltage that is the received voltage information, Vinv is the input DC voltage to the inverter, VCTXpp is a peak voltage across a transmitter tuning capacitor, and C0 and C1 are fit coefficients.

The power transfer level can be computed in accordance with the equation:

P_{target}=k²·C_{pwr}

where Ptarget is power deliverable to the receiver, k is the coupling factor, and Cpwr is a constant for a transmitter/receiver combination stored in a memory of the controller and selected based on the received receiver identifying information. Cpwr can be stored in a memory of the controller and retrieved based at least in part on the received receiver identifying information. Cpwr can be contained in the received receiver identifying information. Cpwr can be computed according to the formula:

$${C}_{pwr} = \frac{{P}_{rect\_max} + {R}_{X L o s s}}{{k}_{min}^{2}}$$

where Prect_max is the maximum total power level required by the receiver, RXLoss is the power lost in the receiver, and kmin is the minimum coupling coefficient that corresponds to a maximum acceptable displacement between transmitter and receiver.

A wireless power transfer device can include a wireless power coil that magnetically couples to a corresponding coil of another wireless power transfer device and a controller and communication module that receives identifying information from the other wireless power transfer device, receives voltage information from the other wireless power transfer device, computes a coupling factor with the other wireless power transfer device based at least in part on the received identifying information and the received voltage information, computes a power transfer level based on the computed coupling factor, and negotiates a power contract with the other wireless power transfer device based at least in part on the computed power transfer level.

The identifying information can specifically identify the other wireless power transfer device. The identifying information can identify the other wireless power transfer device as a member of a class of wireless power transfer devices.

The coupling factor is computed in accordance with the equation:

$$k = \frac{{C}_{0} \cdot {V}_{rect}}{{V}_{i n v} + V {CTX}_{p p}} + C 1$$

where k is the coupling factor, Vrect is a rectifier voltage of a wireless power receiver, Vinv is a DC input voltage of an inverter of a wireless power transmitter, VCTXpp is a peak voltage across a transmitter tuning capacitor, and C0 and C1 are fit coefficients. The wireless power transfer device can be the wireless power receiver and the other wireless power transfer device is the wireless power transmitter, and Vinv and VCTXpp are at least a part of the received voltage information. The power transfer level is computed in accordance with the equation:

P_{target}=k²·C_{pwr}

where Ptarget is power deliverable to the wireless power receiver, k is the coupling factor, and Cpwr is a constant for a transmitter/receiver combination stored in a memory of the controller and communication module and selected based on the received identifying information. Cpwr can be stored in a memory of the controller and retrieved based at least in part on the received identifying information. Cpwr can be contained in the received identifying information. Cpwr can be computed according to the formula:

$${C}_{pwr} = \frac{{P}_{rect\_max} + {R}_{X L o s s}}{{k}_{min}^{2}}$$

where Prect_max is the maximum total power level required by the receiver, RXLoss is the power lost in the receiver, and kmin is the minimum coupling coefficient that corresponds to a maximum acceptable displacement between transmitter and receiver.

The power transfer level can be computed in accordance with the equation:

P_{target}=k²·C_{pwr}

where Ptarget is power deliverable to the wireless power receiver, k is the coupling factor, and Cpwr is a constant for a transmitter/receiver combination stored in a memory of the controller and communication module and selected based on the received identifying information. Cpwr can be stored in a memory of the controller and retrieved based at least in part on the received identifying information. Cpwr can be contained in the received identifying information. Cpwr can be computed according to the formula:

$${C}_{pwr} = \frac{{P}_{rect\_max} + {R}_{X L o s s}}{{k}_{min}^{2}}$$

where Prect_max is the maximum total power level required by the receiver, RXLoss is the power lost in the receiver, and kmin is the minimum coupling coefficient that corresponds to a maximum acceptable displacement between transmitter and receiver.

### BRIEF DESCRIPTION OF THE DRAWINGS

FIG. 1 illustrates a block diagram of a wireless power transfer system.

FIGS. 2A-2C illustrate various configurations of a wireless power transfer system.

FIG. 3 illustrates tables of power transfer levels for a wireless power transfer system.

FIG. 4 illustrates a simplified schematic of a wireless power transfer system.

FIG. 5 illustrates a process for determining a target power transfer level in a wireless power transfer system.

FIG. 6 illustrates tables of power transfer levels for a wireless power transfer system.

FIG. 7 illustrates a process for computing a wireless power transfer level in a wireless power transfer system.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a drawing, refers to the same element throughout the several drawings, though it may not be repeated in every drawing. The drawings are not to scale unless otherwise indicated, and the proportions of certain parts may be exaggerated to better illustrate details and features of the present disclosure.

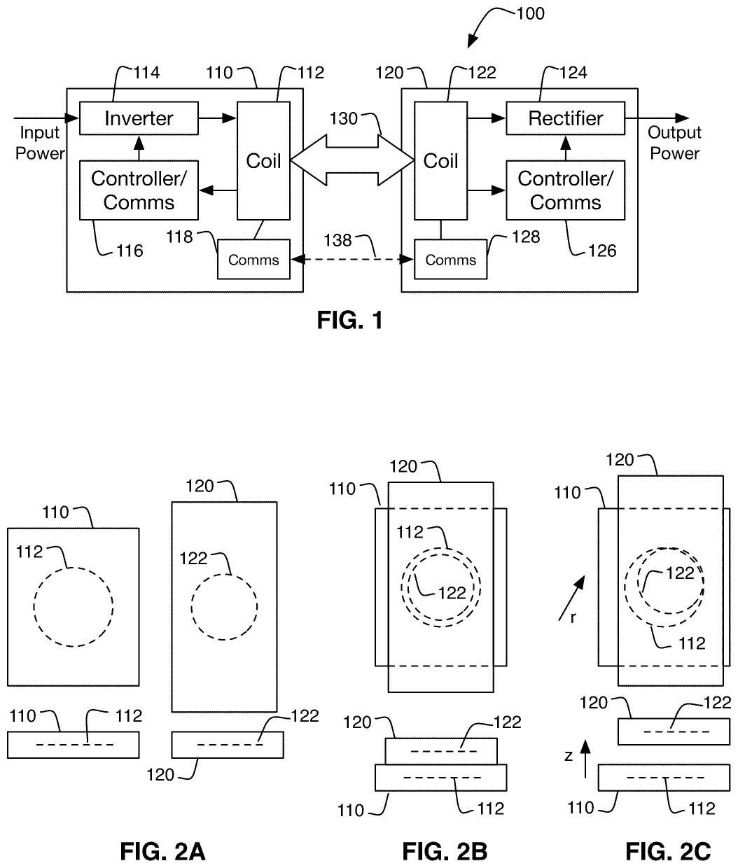

FIG. 1 illustrates a simplified block diagram of a wireless power transfer system 100. Wireless power transfer system includes a power transmitter (PTx) 110 that transfers power to a power receiver (PRx) 120 wirelessly, such as via inductive coupling 130. Power transmitter 110 may receive input power that is converted to an AC voltage having particular voltage and frequency characteristics by an inverter 114. Inverter 114 may be controlled by a controller/communications module 116 that operates as further described below. In various embodiments, the inverter controller and communications module may be implemented in a common system, such as a system based on a microprocessor, microcontroller, or the like. In other embodiments, the inverter controller may be implemented by a separate controller module and communications module that have a means of communication between them. Inverter 114 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

Inverter 114 may deliver the generated AC voltage to a transmitter coil 112. In addition to a wireless coil allowing magnetic coupling to the receiver, the transmitter coil block 112 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless transmitter coil may also include a core of magnetically permeable material (e.g., ferrite) configured to affect the flux pattern of the coil in a way suitable to the particular application. The teachings herein may be applied in conjunction with any of a wide variety of transmitter coil arrangements appropriate to a given application.

PTx controller/communications module 116 may monitor the transmitter coil and use information derived therefrom to control the inverter 114 as appropriate for a given situation. For example, controller/communications module may be configured to cause inverter 114 to operate at a given frequency or output voltage depending on the particular application. In some embodiments, the controller/communications module may be configured to receive information from the PRx device and control inverter 114 accordingly. This information may be received via the power transmission coils (i.e., in-band communication) or may be received via a separate communications channel (not shown, i.e., out-of-band communication). For in-band communication, controller/communications module 116 may detect and decode signals imposed on the magnetic link (such as voltage, frequency, or load variations) by the PRx to receive information and may instruct the inverter to modulate the delivered power by manipulating various parameters of the generated voltage (such as voltage, frequency, etc.) to send information to the PRx. In some embodiments, controller/communications module may be configured to employ frequency shift keying (FSK) communications, in which the frequency of the inverter signal is modulated, to communicate data to the PRx. Controller/communications module 116 may be configured to detect amplitude shift keying (ASK) communications or load modulation-based communications from the PRx. In either case, the controller/communications module 126 may be configured to vary the current drawn on the receiver side to manipulate the waveform seen on the Tx coil to deliver information to from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 116 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry.

PTx device 110 may optionally include other systems and components, such as a separate communications (“comms”) module 118. In some embodiments, comms module 118 may communicate with a corresponding module tag in the PRx via the power transfer coils. In other embodiments, comms module 118 may communicate with a corresponding module using a separate physical channel 138.

As noted above, wireless power transfer system also includes a wireless power receiver (PRx) 120. Wireless power receiver can include a receiver coil 122 that may be magnetically coupled 130 to the transmitter coil 112. As with transmitter coil 112 discussed above, receiver coil block 122 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless receiver coil may also include a core of magnetically permeable material (e.g., ferrite) configured to affect the flux pattern of the coil in a way suitable to the particular application. The teachings herein may be applied in conjunction with any of a wide variety of receiver coil arrangements appropriate to a given application.

Receiver coil 122 outputs an AC voltage induced therein by magnetic induction via transmitter coil 112. This output AC voltage may be provided to a rectifier 124 that provides a DC output power to one or more loads associated with the PRx device. Rectifier 124 may be controlled by a controller/communications module 126 that operates as further described below. In various embodiments, the rectifier controller and communications module may be implemented in a common system, such as a system based on a microprocessor, microcontroller, or the like. In other embodiments, the rectifier controller may be implemented by a separate controller module and communications module that have a means of communication between them. Rectifier 124 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

PRx controller/communications module 126 may monitor the receiver coil and use information derived therefrom to control the rectifier 124 as appropriate for a given situation. For example, controller/communications module may be configured to cause rectifier 124 to operate provide a given output voltage depending on the particular application. In some embodiments, the controller/communications module may be configured to send information to the PTx device to effectively control the power delivered to the receiver. This information may be received sent via the power transmission coils (i.e., in-band communication) or may be sent via a separate communications channel (not shown, i.e., out-of-band communication). For in-band communication, controller/communications module 126 may, for example, modulate load current or other electrical parameters of the received power to send information to the PTx. In some embodiments, controller/communications module 126 may be configured to detect and decode signals imposed on the magnetic link (such as voltage, frequency, or load variations) by the PTx to receive information from the PTx. In some embodiments, controller/communications module 126 may be configured to receive frequency shift keying (FSK) communications, in which the frequency of the inverter signal has been modulated to communicate data to the PRx. Controller/communications module 126 may be configured to generate amplitude shift keying (ASK) communications or load modulation-based communications from the PRx. In either case, the controller/communications module 126 may be configured to vary the current drawn on the receiver side to manipulate the waveform seen on the Tx coil to deliver information to from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 126 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry.

PRx device 120 may optionally include other systems and components, such as a communications module 128. In some embodiments, comms module 128 may communicate with a corresponding module in the PTx via the power transfer coils. In other embodiments, comms module 128 may communicate with a corresponding module or tag using a separate physical channel 138.

Numerous variations and enhancements of the above-described wireless power transmission system 100 are possible, and the following teachings are applicable to any of such variations and enhancements.

Wireless power transfer as described above depends on the degree of electromagnetic coupling between the PTx and the PRx. For example, in inductive charging systems, the transmitter coil 112 and the receiver coil 122 may be thought of as a loosely coupled transformer. As such, the relative position of the PTx and PRx can affect the degree of magnetic coupling between the PTx and PRx, which, in turn, can affect the power transfer capability of the system. FIG. 2A illustrates a simplified diagram of a PTx (110)-PRx (120) system. Both devices are illustrated in plan view (upper part of the diagram) and an edge-on section view (lower part of the diagram). PTx device 110 includes transmitter coil 112, and PRx device 120 includes a receiver coil 122. In some embodiments, PTx device 110 may be a wireless charging pad, mat, or stand (or other wireless power transfer device), and PRx device 120 may be a mobile phone, tablet computer, smart watch, (or other wireless power receiver device). Although the respective devices are depicted as generally rectangular in shape with generally circular charging coils, it is to be appreciated that other configurations are also possible.

FIG. 2B illustrates the PTx 110 and PRx 120 in an “optimal” alignment. In FIG. 2B, the devices are horizontally aligned (as depicted in the plan view) and vertically aligned and as close as possible (as illustrated in the sectional view). In this context, horizontal and vertical are merely used as terms of convenience, and the true orientation of the system may vary, and the following description is applicable to a system in any such orientation, although “horizontal” and “vertical” will continue to be used for contextual clarity. FIG. 2C illustrates the devices with a slight misalignment. More specifically, there is a radial displacement “r” that can be appreciated by noting that the centers of coils 112 and 122 are no-longer co-incident in the plan view. Such radial displacement may be caused by any number of things, for example, a user slightly misplacing a phone with respect to a charging pad. Furthermore, there is also a vertical displacement “z” that can be appreciated by noting the separation between PTx device 110 and PRx device 120 in the sectional view. This vertical displacement may also be caused by any number of things, for example, a phone enclosed in a case or cover. The sectional view also illustrates the lateral/radial displacement. It will be appreciated that in some situation, only a radial displacement or only a vertical displacement may be present.

In any case, the offsets described above can reduce the degree of magnetic coupling between the PTx and PRx devices. This reduced magnetic coupling can limit the amount of power that can be delivered from PTx 110 to PRx 120 while remaining within the performance limitations of PTx device 110. More specifically, reduced coupling between PTx 110 and PRx 120 reduces the fraction of the power transmitted from PTx 110 that is received by PRx 120. PTx 110 has a maximum operating voltage and a maximum current that can be supplied, effectively resulting in a maximum power transfer level. Additionally, in some applications PTx controller 116 may become unstable attempting to supply a power level requested by PRx controller 126 that is not possible/feasible with a given degree of coupling. Thus, as the coupling between PTx 110 and PRx 120 decreases, PTx may not be capable of supplying the level of power requested by PRx 120. In some such cases, it may be desirable for PTx 110 and PRx 120 to negotiate a power contract that specifies the level of power that the PTx can supply and that the PRx expects to receive.

Such a power contract can be based, at least in part, on an estimation of the maximum available power transfer from PTx 110 to PRx 120 based on the limitations of the system imposed by the degree of coupling therebetween. One way to achieve such an estimate is based on measurements of voltage gains from PTx 110 to PRx 120. More specifically, PTx 110 and PRx 120 can operate in various pre-determined fixed loading conditions, and the PTx can compute the gain for that loading condition by dividing the inverter output voltage Vinv (FIG. 4) (i.e., the input voltage to the inverter 114) by the rectifier output voltage Vrect (FIG. 4) (i.e., the rectified voltage after the rectifier). In some cases, the respective loading conditions may be determined by an industry standard specification or by negotiation/agreement between the devices. In any case, a negotiated power contract can include a power target or limit that is a function of these estimated voltage gains.

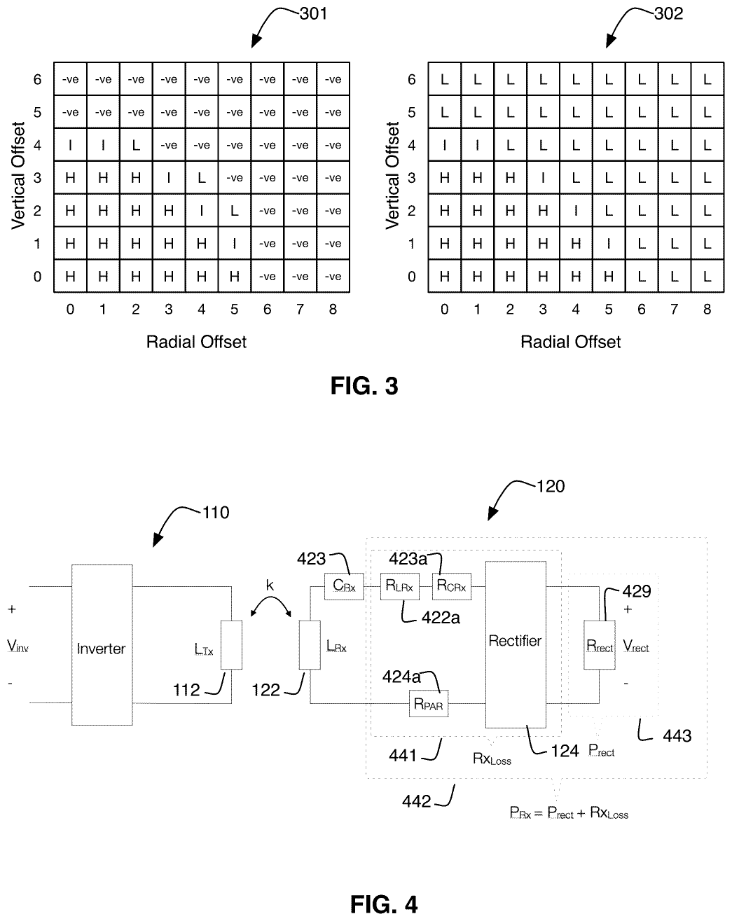

FIG. 3 illustrates a table 301 that plots estimated power transfer levels for varying values of radial offset (r) and vertical offset (z) for an exemplary embodiment. It is to be understood that these values are merely exemplary, and different values might be computed for different systems having different physical, electrical, and magnetic properties. The estimated power transfer levels can be in watts, and the radial offsets can be distances measured in millimeters. For values that are greater than or equal to a high power transfer level (e.g., 15 W), an “H” is presented. For values that are less than or equal to a lower power transfer level (e.g., 5 W), an “L” is presented. For values between these two thresholds an “I” (for intermediate) is presented. In some cases, the estimated power may be negative (a nonsensical result), in which case “-ve” is indicated. Thus, at a radial/vertical offset of 0,0, the estimated power transfer capability might be high (e.g., 28 W which is greater than the power transfer level of 15 W), falling off to −30 W (a non-sensical negative value presented as “-ve”) at a radial offset of 8 mm, and falling off to −15 W (another non-sensical negative value presented as “-ve”) at a vertical offset of 6 mm. It should be noted that the negative values result from a power estimation technique that relies on the product of the voltage gains determined under different loading conditions. More specifically, if one of the measured voltage gains is negative, it will produce a negative power delivery level, which is somewhat nonsensical.

To address these and other inaccuracies of the voltage gain-based estimation method, table 302 of FIG. 3 shows target power levels that may be set based on the estimated power calculation of table 301. In general, for values greater than or equal to a high power transfer level (e.g., 15 W), the power target may be set to the high power transfer level (designated “H”), which may be a rated power level of PTx 110. For estimated power transfer capabilities below low power transfer level (e.g., 5 W), the power target may be set to the low power transfer level (designated “L”), which may be a minimal power transfer target specified by an industry standard. This power transfer target level may also be sufficiently below the maximum capability of PTx 110 that it does not result in controller instability or other operational issues. For intermediate power transfer estimates, the power contract can be set at one or more predefined intermediate levels (designated “I”). Each of the provided values is merely an example, and any suitable power levels can be used depending on the particular implementation.

As briefly noted above, power estimation techniques based on measured voltage gains under differing loading conditions can suffer from accuracy problems. Additionally, performing the tests at various load conditions can also be time consuming, which may undesirably extend the startup time between when a PRx device is placed on the PTx and when full power level wireless transfer begins. Additionally, gain measurements can suffer from a number of inaccuracies due to noise, etc. Thus, it may be preferable to provide power estimates based on a direct measurement of coupling factor “k” (FIG. 4).

FIG. 4 illustrates a partial simplified electrical schematic of a wireless power transfer system including a PTx 110, represented by inverter input voltage Vinv applied to the inverting bridge (e.g., full bridge, half bridge, etc.). PRx 120 includes transmit coil 112/inductor LTx, receive coil 122/inductor LRx, tuning capacitor CRx/423, rectifier 124, and output load 429, represented by resistor Prect. Also included in FIG. 4 are resistors RLRx/422a, RCRx/423a, and RPAR/424a, which are not actual, discrete resistors, but rather correspond to the inherent resistances of receive coil 122, tuning capacitor 423, and other parasitic losses of the system. Thus, the power received PRx/442 may be thought of as including two components: Prect 443, which is the power delivered to the load Rrect/429 and the power losses RXLoss/441 associated with the parasitic resistances.

The power transfer capability of such a wireless power transfer system can be expressed by:

P_{target}=k²·C_{pwr}

Where k is the coupling factor between transmitter and receiver and Cpwr is a property of the receiver that may be determined as described below. For a given degree of coupling, a higher Cpwr value can result in a target power calculation higher than the receiver requirement. Similarly, a lower Cpwr can result in a target power calculation lower than the receiver requirement. Thus, to ensure adequate power delivery, Cpwr can be determined using a “worst case scenario,” i.e., a relative position between PTx 110 and PRx 120 that has the lowest acceptable coupling, i.e., a minimal coupling that still guarantees a specified power transfer level. Thus:

$${C}_{pwr} = \frac{{P}_{rect\_max} + {R}_{X L o s s}}{{k}_{min}^{2}}$$

where Cpwr is the required power coefficient that guarantees maximum power level is targeted during power negotiation, Prect_max is the maximum total power level required by the receiver, RXLoss is the power lost in the receiver (discussed above), and kmin is the minimum coupling coefficient, generally corresponding to a maximum acceptable displacement between PTx 110 and PRx 120. As noted above, this Cpwr factor in the PRx_target computation above is a property of each receiver, which may have different electrical and magnetic properties. As the transmitter can use this value to compute the target power level, the transmitter can have access Cpwr for a receiver. In some cases, the transmitter may be programmed, either initially or via an update, with Cpwr values for a variety of compatible receivers. In other cases, the receiver can provide its Cpwr value to the transmitter as part of an initialization phase.

In some applications, Cpwr may be constant for a particular transmitter/receiver device combination. Additionally, its three constituent elements (Prect_max, RXLoss and kmin) may also be constant for a particular receiver and transmitter device, respectively. In other words, Cpwr and its constituent factors can be determined as a function of the physical, electrical, and magnetic properties of the particular device's construction. Thus, to facilitate power contract negotiation, PTx 110 may store or otherwise access one or more Cpwr values corresponding to one or more receivers or receiver types/classes. In either case, as part of the initialization/power contract negotiation, PTx 110 may identify the PRx 120 with which it is communicating and use an appropriate stored Cpwr value (or its constituent factors) for power estimation as described herein. Additionally, or alternatively, PRx 120 could store its own (P_{rect_max}+R_{XLoss}) value and one or more kmin values corresponding to one or more transmitters or transmitter types. Then as part of the initialization/power contract negotiation process, PRx 120 could provide to PTx 110 its own (P_{rect_max}+R_{XLoss}) value or a suitable Cpwr value. Collectively or individually, this information can be considered as receiver identification information, as it can provide the transmitter with appropriate characteristics of the receiver to allow establishment of an appropriate power contract.

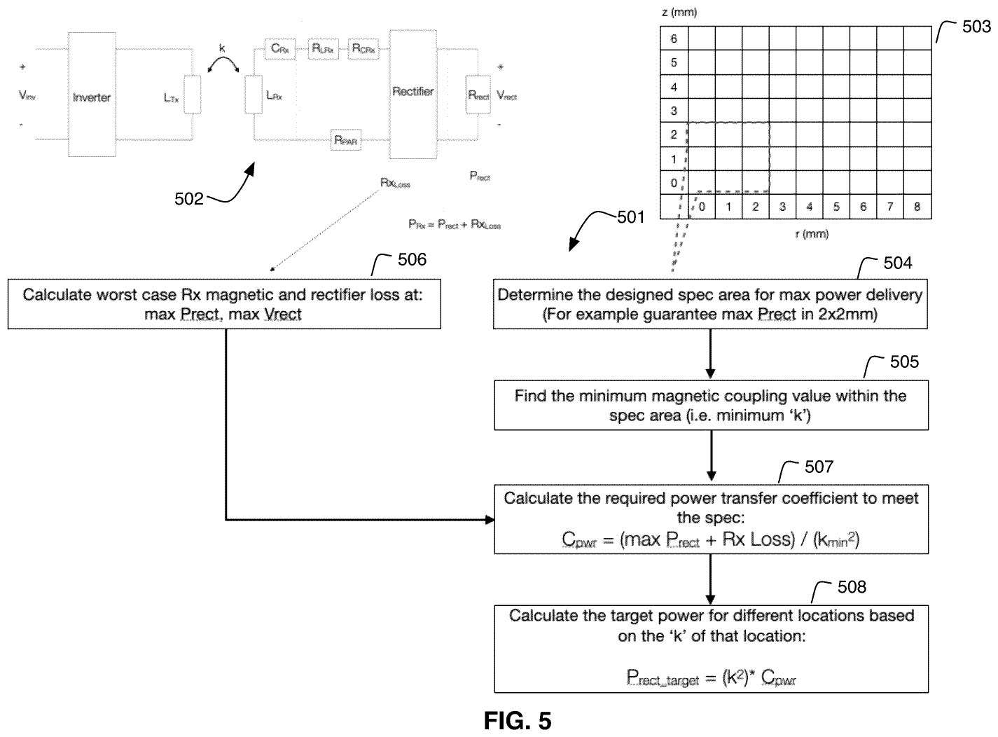

FIG. 5 illustrates a complete exemplary process 501 for computing a power contract target power value for a system 502 using the principles described above. Only certain portions of this method may be performed in the PTx/PRx initialization/negotiation process, as some portions may only be done once as a part of the design/calibration/configuration of the respective receiver device and/or transmitter devices. Table 503 represents a table of power levels like that described above with respect to FIG. 3. In block 504, the designed specified area for maximum power delivery may be determined. As one example, it may be desirable to guarantee maximum power delivery within a 2 mm radial offset and/or a 2 mm vertical offset from perfect alignment. Then, in block 505, a minimum coupling factor kmin that will allow this power transfer level can be determined. Also, in block 506, the worst-case rectifier losses can be determined. In block 507, the minimum coupling factor and worst cases losses can be used to calculate a Cpwr value using the formula described above. This Cpwr value (an example of receiver identifying information) can be provided to the transmitter by programming (including initial configuration or a software/firmware update), communication, or other suitable technique as described above. Finally, in block 508, the transmitter can calculate target power for different locations, i.e., different radial and/or vertical offsets by use of the Prect_target formula discussed above.

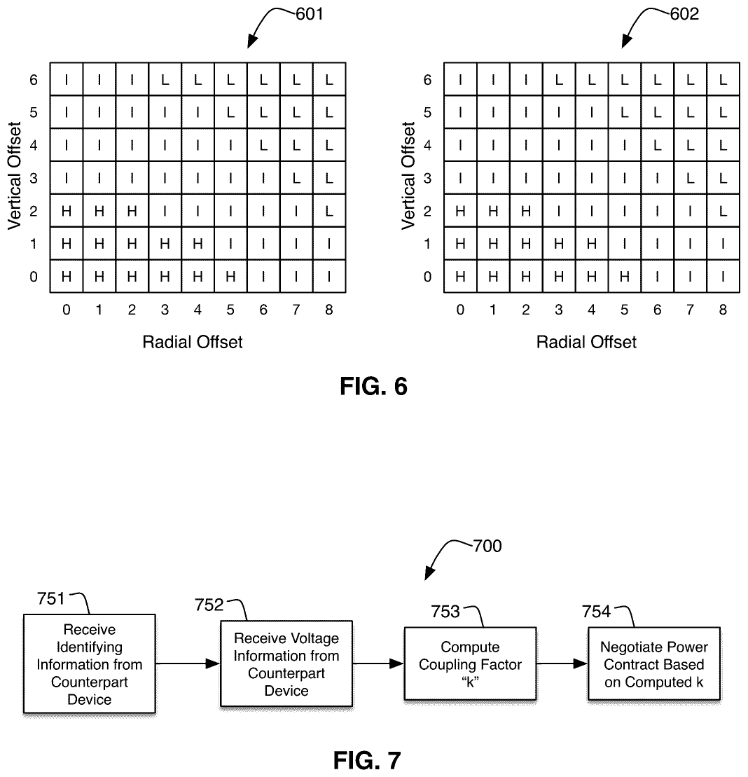

FIG. 6 illustrates a first table 601 of estimated power values using the above-described computation technique. As with table 301 of FIG. 3, estimated power transfer levels for varying values of radial offset (r) and vertical offset (z) are for an exemplary embodiment. It is to be understood that these values are merely exemplary, and different values might be computed for different systems having different physical, electrical, and magnetic properties. The estimated power transfer levels can be in watts, and the radial offsets can be distances measured in millimeters. Thus, at a radial/vertical offset of 0,0, the estimated power transfer capability can be 25 W (designated “H” because it is above an exemplary high power level of 15 W), falling off to 8 W at a radial offset of 8 mm (designated “I” because it is below the exemplary high power level of 15 W but above an exemplary low power level of 5 W), and falling off to 6 W at a vertical offset of 6 mm (designated “I” because it is below the exemplary high power level of 15 W but above an exemplary low power level of 5 W). It should be noted that these values can be both more accurate and more conservative than those computed by the alternative voltage gain-based computation discussed above with reference to FIG. 3.

FIG. 6 also illustrates a second table 602 of power contract target power levels that may optionally be set based on the estimated power calculation of table 601. In general, for values greater than a high power level (e.g., 15 W), the power target may be set to 15 W (designated “H”), which may be a rated power level of PTx 110. For estimated power transfer capabilities below a lower power level (e.g., 5 W), the power target may be set to 5 W (designated “L”), which may be a minimal power transfer target specified by an industry standard. This power transfer target level may also be sufficiently below the maximum capability of PTx 110 that it does not result in controller instability or other operational issues. For intermediate power transfer estimates, the power contract can be set at one or more predefined intermediate levels (designated “I”), as illustrated in table 602 and generally as discussed above.

The foregoing power estimation technique necessitates knowing the coupling factor “k” between PTx 110 and PRx 120. This factor may be obtained using a variety of techniques. In one embodiment, it may be computed according to the following formula:

$${k}_{est} = \frac{{C}_{0} \cdot {V}_{rect}}{{V}_{i n v} + V {CTX}_{p p}} + C 1$$

where kest is the calculated (estimated) coupling factor, Vrect is the rectifier voltage (FIG. 4) measured during startup, Vinv is the inverter input DC voltage on the transmitter side, VCTXpp is the to peak voltage across the transmitter tuning capacitor in series with the power transmit winding (not shown), and C0 and C1 are fit coefficients determined empirically for a given range of coupling factors. Because this depends on voltage measurements or values made in only a single operating condition, the process can be performed more quickly than the multi-load condition voltage gain measurements described above.

FIG. 7 illustrates a flow chart 700 of a power contract negotiation process that may be performed either by a PTx 110 and/or a PRx 120. More specifically, the computation may be performed by a processor that is part of controller 116 or 126 using data stored in a corresponding memory, hardcoded into the respective device, or received from a counterpart device. Beginning at block 751, a device (either PTx or PRx) can receive identifying information from a counterpart device (either a PRx or PTx, respectively). This identifying information can be a simple identifier of the device or device class to which the counterpart belongs, allowing the receiving device to look up a stored Cpwr value or constituent factor for the counterpart device. For example, a transmitter (PTx) might receive from a receiver (PRx) identifying information allowing the transmitter to look up a Cpwr value or a (P_{rect_max}+R_{XLoss}) value corresponding to the receiver device. Alternatively, a receiver (PRx) might receive from a transmitter (PTx) identifying information allowing the receiver to look up a Cpwr value or a kmin value corresponding to the transmitter device. In another alternative, the counterpart device could provide its constituent factor (P_{rect_max}+R_{XLoss} for a PRx or kmin for a PTx) directly. In any case, the receiving device can determine a suitable Cpwr value from the identifying information.

In block 752, a device (PTx or PRx) can receive voltage information from the counterpart device. This voltage information may be the rectifier voltage Vrect if the counterpart device is a PRx device or may be the inverter voltage and transmitter tuning capacitor peak to peak voltage if the counterpart device is a PTx device. In either case, the voltage information may be combined with a local voltage measurement to compute (or estimate) the coupling factor “k” between the devices (block 753). (In either case, the device performing this computation may also have stored any fit coefficients required for the computation.) From this k value and the previously determined Cpwr value, a power target for a negotiated power contract may be computed as described above (block 754).

The foregoing describes exemplary embodiments of wireless power transfer systems employing coupling-based power transfer estimation and power supply contract negotiation. Such systems may be used in a variety of applications but may be particularly advantageous when used in conjunction with wireless power transfer systems for personal electronic devices such as mobile computing devices (e.g., laptop computers, tablet computers, smart phones, and the like) and their accessories (e.g., wireless earphones, styluses and other input devices, etc.) as well as wireless charging accessories (e.g., charging mats, pads, stands, etc.). Although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

The foregoing describes exemplary embodiments of wireless power transfer systems that are able to transmit certain information amongst the PTx and PRx in the system. The present disclosure contemplates this passage of information improves the devices' ability to provide wireless power signals to each other in an efficient manner to facilitate battery charging, such as by sharing of the devices' power handling capabilities with one another. Entities implementing the present technology should take care to ensure that, to the extent any sensitive information is used in particular implementations, that well-established privacy policies and/or privacy practices are complied with. In particular, such entities would be expected to implement and consistently apply privacy practices that are generally recognized as meeting or exceeding industry or governmental requirements for maintaining the privacy of users. Implementers should inform users where personally identifiable information is expected to be transmitted in a wireless power transfer system, and allow users to “opt in” or “opt out” of participation. For instance, such information may be presented to the user when they place a device onto a power transmitter, if the power transmitter is configured to poll for sensitive information from the power receiver.

Risk can be minimized by limiting the collection of data and deleting data once it is no longer needed. In addition, and when applicable, data de-identification can be used to protect a user's privacy. For example, a device identifier may be partially masked to convey the power characteristics of the device without uniquely identifying the device. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy. Robust encryption may also be utilized to reduce the likelihood that communication between inductively coupled devices are spoofed.

1. A wireless power transmitter comprising:
an inverter that receives input power and generates an AC output voltage;
a wireless power transmitter coil coupled to the AC output that magnetically couples to a corresponding coil of a wireless power receiver; and
a controller and communication module, that:
receives identifying information from the wireless power receiver;
receives voltage information from the wireless power receiver;
computes a coupling factor with the wireless power receiver based at least in part on the received identifying information and the received voltage information;
computes a power transfer level based on the computed coupling factor; and
negotiates a power contract with the wireless power receiver based at least in part on the computed power transfer level.

2. The wireless power transmitter of claim 1 wherein the identifying information specifically identifies the wireless power receiver.

3. The wireless power transmitter of claim 1 wherein the identifying information identifies the wireless power receiver as a member of a class of wireless power receivers.

4. The wireless power transmitter of claim 1 wherein the coupling factor is computed in accordance with the equation:
$$k = \frac{{C}_{0} \cdot {V}_{rect}}{{V}_{i n v} + V {CTX}_{p p}} + C 1$$
where k is the coupling factor, Vrect is a rectifier voltage that is at least a part of the received voltage information, Vinv is the input DC voltage to the inverter, VCTXpp is a peak voltage across a transmitter tuning capacitor, and C0 and C1 are fit coefficients.

5. The wireless power transmitter of claim 1 wherein the power transfer level is computed in accordance with the equation:
P_{target}=k²·C_{pwr}
where P_{target} is power deliverable to the receiver, k is the coupling factor, and C_{pwr} is a constant for a transmitter/receiver combination determined by the controller based at least in part on the received receiver identifying information.

6. The wireless power transmitter of claim 5 wherein C_{pwr} is stored in a memory of the controller and retrieved based at least in part on the received receiver identifying information.

7. The wireless power transmitter of claim 5 wherein C_{pwr} is contained in the received receiver identifying information.

8. The wireless power transmitter of claim 5 wherein C_{pwr} is computed according to the formula:
$${C}_{pwr} = \frac{{P}_{rect\_max} + {R}_{X L o s s}}{{k}_{min}^{2}}$$
where Prect_max is the maximum total power level required by the receiver, RXLoss is the power lost in the receiver, and kmin is the minimum coupling coefficient that corresponds to a maximum acceptable displacement between transmitter and receiver.

9. A method performed by a wireless power transmitter of negotiating a wireless power delivery contract with a wireless power receiver, the method comprising:
receiving identifying information from the wireless power receiver via a wireless communication link;
receives voltage information from the wireless power receiver via the wireless communication link;
computing with a processor of the wireless power transmitter a coupling factor with the wireless power receiver based at least in part on the received identifying information and the received voltage information;
computing with the processor a power transfer level based on the computed coupling factor; and
negotiating the wireless power delivery contract based at least in part on the computed power transfer level.

10. The method of claim 9 wherein the identifying information specifically identifies the wireless power receiver.

11. The method of claim 9 wherein the identifying information identifies the wireless power receiver as a member of a class of wireless power receivers.

12. The method of claim 9 wherein the coupling factor is computed in accordance with the equation:
$$k = \frac{{C}_{0} \cdot {V}_{rect}}{{V}_{i n v} + V {CTX}_{p p}} + C 1$$
where k is the coupling factor, Vrect is a rectifier voltage that is the received voltage information, Vinv is the input DC voltage to the inverter, VCTXpp is a peak voltage across a transmitter tuning capacitor, and C0 and C1 are fit coefficients.

13. The method of claim 9 wherein the power transfer level is computed in accordance with the equation:
P_{target}=k²·C_{pwr}
where Ptarget is power deliverable to the receiver, k is the coupling factor, and Cpwr is a constant for a transmitter/receiver combination available to the controller and selected based on the received receiver identifying information.

14. The method of claim 13 wherein C_{pwr} is stored in a memory of the controller and retrieved based at least in part on the received receiver identifying information.

15. The method of claim 13 wherein C_{pwr} is contained in the received receiver identifying information.

16. The method of claim 13 wherein C_{pwr} is computed according to the formula:
$${C}_{pwr} = \frac{{P}_{rect\_max} + {R}_{X L o s s}}{{k}_{min}^{2}}$$
where Prect_max is the maximum total power level required by the receiver, RXLoss is the power lost in the receiver, and kmin is the minimum coupling coefficient that corresponds to a maximum acceptable displacement between transmitter and receiver.

17. A wireless power transfer device comprising:
a wireless power coil that magnetically couples to a corresponding coil of another wireless power transfer device; and
a controller and communication module, that:
receives identifying information from the other wireless power transfer device;
receives voltage information from the other wireless power transfer device;
computes a coupling factor with the other wireless power transfer device based at least in part on the received identifying information and the received voltage information;
computes a power transfer level based on the computed coupling factor; and
negotiates a power contract with the other wireless power transfer device based at least in part on the computed power transfer level.

18. The wireless power transfer device of claim 17 wherein the identifying information specifically identifies the other wireless power transfer device.

19. The wireless power transfer device of claim 17 wherein the identifying information identifies the other wireless power transfer device as a member of a class of wireless power transfer devices.

20. The wireless power transfer device of claim 17 wherein the coupling factor is computed in accordance with the equation:
$$k = \frac{{C}_{0} \cdot {V}_{rect}}{{V}_{i n v} + V {CTX}_{p p}} + C 1$$
where k is the coupling factor, Vrect is a rectifier voltage of a wireless power receiver, Vinv is a DC input voltage of an inverter of a wireless power transmitter, VCTXpp is a peak voltage across a transmitter tuning capacitor, and C0 and C1 are fit coefficients.

21. The wireless power transfer device of claim 20 wherein:
the wireless power transfer device is the wireless power receiver and the other wireless power transfer device is the wireless power transmitter; and
Vinv and VCTXpp are at least a part of the received voltage information.

22. The wireless power transfer device of claim 20 wherein the power transfer level is computed in accordance with the equation:
P_{target}=k²·C_{pwr}
where Ptarget is power deliverable to the wireless power receiver, k is the coupling factor, and Cpwr is a constant for a transmitter/receiver combination available to the controller and communication module and selected based on the received identifying information.

23. The wireless power transfer device of claim 22 wherein Cpwr is stored in a memory of the controller and retrieved based at least in part on the received identifying information.

24. The wireless power transfer device of claim 22 wherein Cpwr is contained in the received identifying information.

25. The wireless power transfer device of claim 22 wherein Cpwr is computed according to the formula:
$${C}_{pwr} = \frac{{P}_{rect\_max} + {R}_{X L o s s}}{{k}_{min}^{2}}$$
where Prect_max is the maximum total power level required by the receiver, RXLoss is the power lost in the receiver, and kmin is the minimum coupling coefficient that corresponds to a maximum acceptable displacement between transmitter and receiver.

26. The wireless power transfer device of claim 17 wherein the power transfer level is computed in accordance with the equation:
P_{target}=k²·C_{pwr}
where Ptarget is power deliverable to the wireless power receiver, k is the coupling factor, and Cpwr is a constant for a transmitter/receiver combination available to the controller and communication module and selected based on the received identifying information.

27. The wireless power transfer device of claim 26 wherein Cpwr is stored in a memory of the controller and retrieved based at least in part on the received identifying information.

28. The wireless power transfer device of claim 26 wherein Cpwr is contained in the received identifying information.

29. The wireless power transfer device of claim 26 wherein Cpwr is computed according to the formula:
$${C}_{pwr} = \frac{{P}_{rect\_max} + {R}_{X L o s s}}{{k}_{min}^{2}}$$
where Prect_max is the maximum total power level required by the receiver, RXLoss is the power lost in the receiver, and kmin is the minimum coupling coefficient that corresponds to a maximum acceptable displacement between transmitter and receiver.
